(19) United States
(12) Patent Application Publication
(10) Pub. No.: US 2006/0044285 A1
(43) Pub. Date: Mar. 2, 2006

(54) Replay apparatus and replay method

(76) Inventors: Kazuhiro Sato, Sagamihara (JP); Tomomi Kaminaga, Tokyo (JP); Junichi Ito, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/203,342

(22) Filed: Aug. 12, 2005

(30) Foreign Application Priority Data
Aug. 30, 2004 (JP) 2004-250059

(51) Int. Cl. G09G 5/00

(52) U.S. Cl. 345/173

(57) ABSTRACT

A replay apparatus which comprises a touch panel placed on and overlapping with a display monitor; a detection circuit for detecting an operating position of the touch panel; a switching circuit for switching between first and second operation states, the former to display electronic data and operator assist mark for indicating an operation area of the touch panel in the display monitor, and the latter to display only the electronic data in the display monitor; a selection circuit for calculating an operating parameter based on operating positions relating to a tracing operation in an operation area detected by the detection circuit at least two different times when the tracing operation is carried out in the operation area of the touch panel in the first operation state, and for selecting the electronic data based on the calculation result.

### CROSS REFERENCE TO RELATED APPLICATIONS

This application is based upon and claims the benefit of priority from the prior Japanese Patent Application No. 2004-250059, filed Aug. 30, 2004, the entire contents of which are incorporated herein by reference.

### BACKGROUND OF THE INVENTION

1. Field of the Invention

The present invention relates to an apparatus and its related method for selecting and replaying electronic data such as that of images, music and text.

2. Description of the Related Art

There have conventionally been apparatuses for replaying electronic data such as images, music, and text. Such a replay apparatus allows replay of electronic data such as images, music and text which are stored in memory according to user instruction. In recent years, use of large capacity memory has been increasingly popular, taking advantage of the reduced price thereof.

For example, in a digital camera which is also an image replay apparatus, the number of images that one memory device is capable of recording has been increasing, hence requiring search means for efficiently searching for a desired image in a short amount of time out of a memory which has recorded a large number of images. One well known and used means for searching for an image is to display a catalog of a plurality of thumbnail images and index them in sequence by operating an arrow key. Other methods include using a jog dial. For example, a Japanese laid-open patent application publication No. 11-231989 has proposed a method for equipping a jog dial on the back of an LCD (liquid crystal display) mounting face and switching images to be displayed therein in sequence according to a rotating operation of the jog dial.

Meanwhile, there is the touch panel as a known input means. A touch panel used to be unsuitable for mobile equipment with a small display screen because of its general requirement for operating surface area, but use of a large size LCD panel for mobile equipment such as a digital camera has been on the increase recently, taking advantage of the reduced price of LCDs, hence the environment has become suitable for the use of touch panels as well.

In equipment such as a digital camera allowing various operations by using a touch panel, image indexing in the form of pressing buttons is generally known as a means for searching for an image, while other methods include the one proposed by a Japanese laid-open patent application publication No. 2004-104594 in which tracing a touch panel surface levelly changes an image display speed in accordance with the tracing direction and speed.

### SUMMARY OF THE INVENTION

An aspect of the present invention is a replay apparatus comprising a record circuit for recording electronic data; a display monitor for displaying the electronic data; a touch panel placed on and overlapping with the display monitor; a detection circuit for detecting an operating position of the touch panel; a switching circuit for switching between first and second operation states, the former to display the electronic data and operator assist mark for indicating an operation area of the touch panel in the display monitor, and the latter to display only the electronic data in the display monitor; a selection circuit for calculating an operating parameter based on operating positions relating to a tracing operation in an operation area detected by the detection circuit at least two different times when the tracing operation is carried out in the operation area of the touch panel in the first operation state, and for selecting the electronic data based on the calculation result.

Another aspect of the present invention is a method for replaying content data for use in a replay apparatus which comprises a record medium recording content data, a display monitor for displaying the content data, and a touch panel placed on and overlapping with the display monitor, comprising a first condition for displaying, in the display monitor, the content data and an operator assist mark for indicating an operation area of the touch panel, selecting the content data based on an operating parameter relating to a tracing operation in the operation area, and displaying the aforementioned selected content data in the display monitor; and a second condition for displaying only the content data in the display monitor, wherein the first and second conditions are switched in accordance with a prescribed operation carried out on the replay apparatus.

Yet another aspect of the present invention is a method for replaying content data for use in a replay apparatus which comprises a record medium for recording content data, a display monitor for displaying the content data, and a touch panel placed on and overlapping with the display monitor, comprising the steps of displaying, in the display monitor, the content data and an operator assist mark for indicating an operation area of the touch panel, selecting the content data based on an operating parameter relating to a tracing operation in the operation area, and displaying the aforementioned selected content data in the display monitor; clearing the operator assist mark and displaying only the selected content data in the display monitor; and switching from one of the two display operation states to the other in accordance with a prescribed operation carried out on the replay apparatus.

### BRIEF DESCRIPTION OF THE DRAWINGS

FIG. 1A is a diagonal perspective view of a digital camera to which a display apparatus according to a first embodiment is applied;

FIG. 1B is a diagonal perspective view of a digital camera to which a display apparatus according to the first embodiment is applied;

FIG. 2 shows a basic comprisal of a digital camera;

FIG. 3 exemplifies a screen displayed by an LCD (liquid crystal display) monitor when a camera operator operates a touch panel for selecting image data, et cetera, in a replay mode;

FIG. 4 exemplifies a change of screen displayed by an LCD monitor when a camera operator operates a touch panel for selecting a desired image data, et cetera, in a replay mode according to the first embodiment;

FIG. 5A is the first flowchart showing an operation of a digital camera according to the first embodiment;

FIG. 5B is the second flow chart showing an operation of a digital camera according to the first embodiment;

FIG. 5C is the third flow chart showing an operation of a digital camera according to the first embodiment;

FIG. 6 shows a track (also called an “operating track”) when a camera operator uses her/his finger for tracing an operation area of a touch panel by following an operator assist mark;

FIG. 7 describes a method for figuring out an angle as a distance of an operating track;

FIG. 8A is the first flowchart showing an operation of a digital camera according to a second embodiment;

FIG. 8B is the second flow chart showing an operation of a digital camera according to the second embodiment;

FIG. 8C is the third flow chart showing an operation of a digital camera according to the second embodiment;

FIG. 9 shows an operator assist mark according to a third embodiment; and

FIG. 10 exemplifies a change of screen displayed by an LCD monitor when a camera operator operates a touch panel for selecting a desired image data, et cetera, in a replay mode according to the third embodiment.

### DESCRIPTION OF THE PREFERRED EMBODIMENTS

The following is a detailed description of the preferred embodiment of the present invention in reference to the accompanying drawings.

### First Embodiment

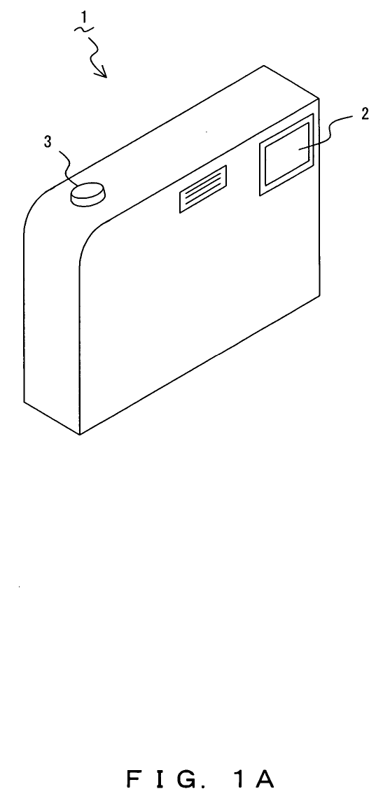

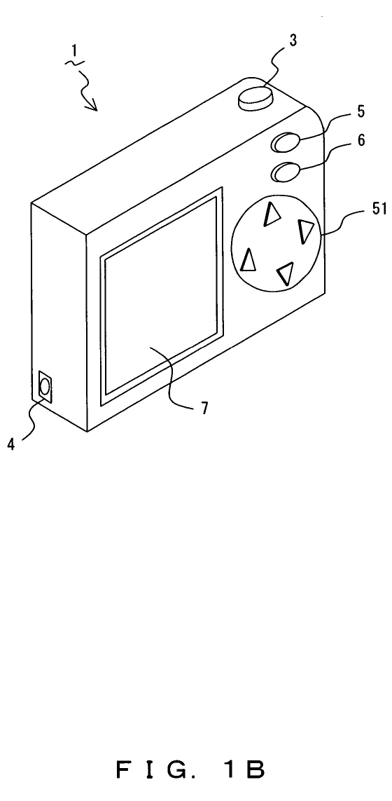

FIGS. 1A and 1B are diagonal perspective views of a digital camera to which a display apparatus according to a first embodiment of the present invention is applied.

As shown by FIGS. 1A and 1B, a digital camera 1 comprises a photo lens 2 on the front thereof, a release switch 3 on the top face of the camera for instructing to take a photograph and a jack 4 on the left side of the camera for connecting a headphone, et cetera; and comprises a record mode switch 5 for instructing to set up a photography (N.B.; also truncated as “photo” hereinafter) mode, a play mode switch 6 for instructing to set up a replay mode, et cetera, an arrow switch 51 for setting up an operating condition of the camera and a touch panel 7 mounted on the LCD monitor for enabling various inputs and instructions to the camera by way of operations such as touching or sliding, et cetera, with a finger, special pen, stick, et cetera, at the rear of the camera. Incidentally a “sliding” operation includes tracing, scrubbing and movably supporting, et cetera.

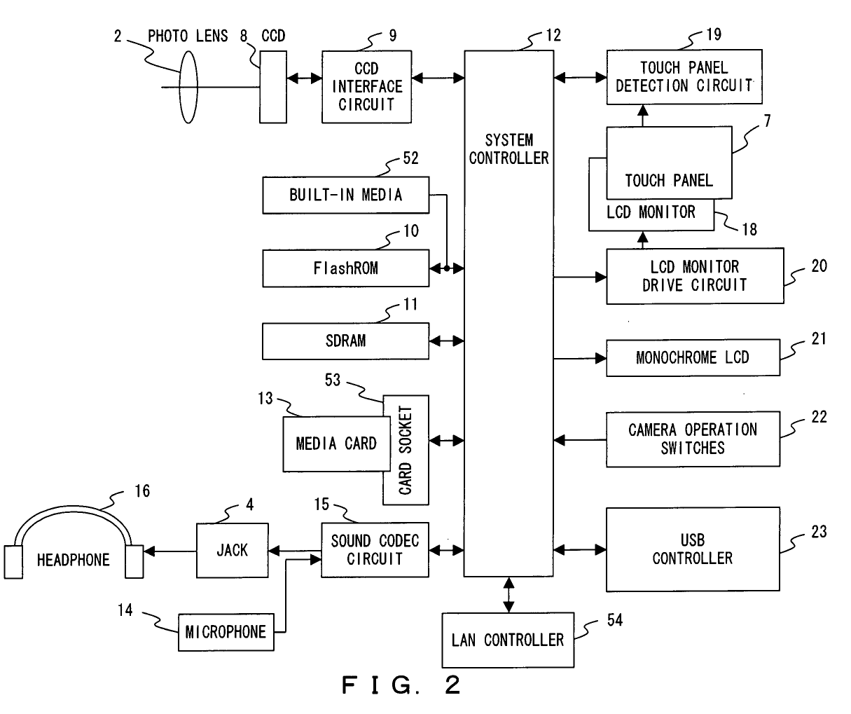

FIG. 2 shows a basic comprisal of digital camera 1.

In FIG. 2, a CCD (charge coupled device) 8 performs photoelectric conversion of an object image photographed by the photo lens to an electric signal (i.e., analog electrical signal). A CCD interface circuit 9 acquires image data in a certain format (i.e., digital electronic data) by performing a prescribed image pickup processing of the electric signal which has been photo-electrically converted by the CCD 8.

A flash ROM 10 stores a control program for controlling the entire camera 1 and various data necessary for executing the program.

A built-in media 52 is a storage circuit equipped within the camera, storing photographed image data, voice data, or content data inputted from outside the camera. A storage circuit is compatible with a NAND type flash ROM, compact HDD (hard disk), et cetera.

An SDRAM (synchronous DRAM) 11 is used as a temporary storage for the image data acquired by the CCD interface circuit 9, as a work area for a system controller 12, et cetera.

The system controller 12 controls the operation of the entire camera 1 by reading the control program out of the flash ROM 10 and executing it; and also carries out a prescribed image processing and a compression/decompression processing for an image data.

A card socket 53 is connected with a media card 13 which is attached or removed to a camera. A media card 13 is compatible with a memory card with a built in NAND type flash ROM, a card with a built in compact HDD, et cetera. As with the built-in media 52, the media card 13 stores photographed image data, recorded voice data and content data. When the media card 13 is inserted into the camera, the user can selectively use either the built-in media 52 or the media card 13. The camera allows the existence of the two storage media therein.

A microphone 14 converts sound to an electrical signal (i.e., analog electrical signal). A sound codec circuit 15 acquires sound data (i.e., digital electronic data) in a certain format by applying a prescribed code processing to the electrical signal converted by the microphone 14. The voice codec circuit 15 acquires a sound signal (i.e., analog electrical signal) in an audio format for an external sound apparatus such as a headphone 16 by applying a prescribed decoding processing to the voice data. The jack 4 is a connector for connecting the sound codec circuit 15 to an external sound apparatus such as the headphone 16 which emits sound in accordance with the inputted sound signal.

The touch panel 7 is a transparent screen, enabling various inputs or instructions to the camera 1 by an operation such as touching and tracing the touch panel with a finger, special pen or stick. A touch panel detection circuit 19 detects a contact position of the finger, special pen or stick, et cetera, while it is in touch with the touch panel 7.

An LCD monitor drive circuit 20 drives an LCD monitor 18 which displays an image, various menus, et cetera, as driven by the LCD monitor drive circuit 20.

A monochrome LCD 21 displays a setup condition of the camera 1. Camera operation switches 22, including the above mentioned release switch 3, record mode switch 5 and play mode switch 6, are switches for issuing prescribed instructions to the camera 1. A USB (universal serial bus) controller 23 controls a data transmission & reception between the camera 1 and external equipment connected by way of a USB which enables an output of electronic data stored by the built-in media 52 or media card 13 to an external apparatus (e.g., personal computer; “PC” hereinafter), and also enables content (e.g., music data), which are desired for replaying by the camera, to be stored in the built-in media 52 or media card 13. A LAN (local area network) controller 54 is used for storing content to be replayed by the camera in the built-in media 52 or media card 13 without the use of a PC.

With a comprisal as described above, an operation of the record mode switch 5 for example to select a photo mode, followed by operating the release switch 3 makes an objective image focused on the imaging plane be photo-electrically converted into an electrical signal by the CCD 8, and further a prescribed image processing by the CCD interface circuit 9 is applied, thereby acquiring image data of a predefined format. A prescribed image processing is then applied to the image data by the system controller 12, followed by image compression processing, and storage to the media card 13. Methods for correlating image data with a frame number include: (1) recording image data in the form of including the frame number in a part of the file name; (2) recording the frame number in the attribute information of an image data. Recording image data in the media card 13 by using a method such as the above mentioned makes it possible to search based on frame number.

Also in the photo mode, an instruction to the camera for recording a sound by a prescribed operation allows a recording for a prescribed period of time, in which case the sound is converted into an electrical signal by the microphone 14 to become sound data in a predefined format as a result of the sound codec circuit 15 applying coding processing to the electrical signal. The sound data is then recorded to the media card 13.

On the other hand, an operation of the play mode switch 6 for example to select a replay mode, followed by an operation of the touch panel 7 with a finger, special pen or stick, as later described, to indicate a selection and replay specific image data from among that recorded to the media card 13 will read the image data out thereof. The system controller 12 applies image expansion processing to the readout image data so as to display it in the LCD monitor 18.

Likewise, an instruction for a selection or replay of specific sound data from among that recorded to the media card 13 will read the sound data out thereof. The sound codec circuit 15 applies decoding processing to the readout sound data so as to let the headphones 16 for example connected to the jack 4 sound.

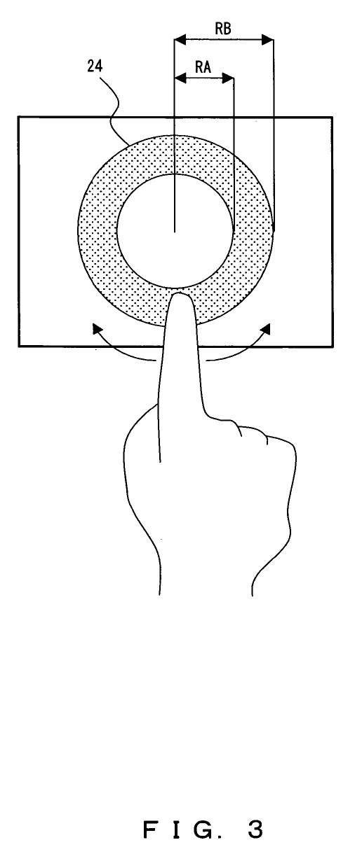

FIG. 3 exemplifies a screen displayed by an LCD monitor 18 when a camera operator operates a touch panel 7 for selecting an image data, et cetera, in the replay mode.

As shown by FIG. 3, when selecting an image data, et cetera, the LCD monitor 18 displays a donut shaped operator assist mark 24 for the purpose of indicating an operation area of the touch panel 7 overlapping with an image (not shown herein) representing photographed image data for example. In this event, the operator assist mark 24 is positioned at the center of the display screen of the LCD monitor 18 in half tone (i.e., semitransparent) so that a superimposed image therewith can be identified. The present embodiment is configured to define the internal and external radii of the donut shaped operator assist mark 24 as RA and RB, respectively.

This comprisal enables the camera operator to operate the operation area of the touch panel 7, which corresponds to an area (i.e., the shaded area of FIG. 3) of the operator assist mark 24 displayed by the LCD monitor 18, by tracing with a finger in the direction of the arrows shown by FIG. 3, et cetera, that is, by an operation of tracing the operator assist mark 24 on the touch panel 7 with a finger in the direction of the arrows shown by FIG. 3, thereby instructing the camera 1 for selecting an image data for example.

Note that FIG. 3 exemplifies only one operator assist mark. Any mark other than that shown by FIG. 3 will be feasible as long as it is a figure or sign for indicating comprehensibly an area of operation (i.e., the area bordered by the RA and RB) for a camera operator.

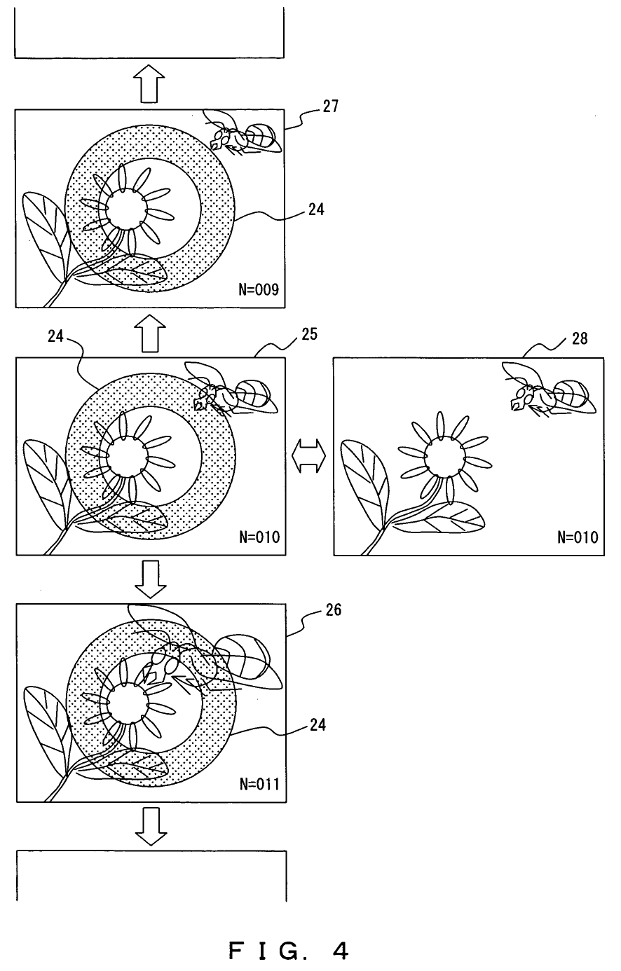

FIG. 4 exemplifies a change of screen displayed by the LCD monitor 18 when a camera operator operates the touch panel 7 for selecting desired image data in the replay mode.

In FIG. 4, a display screen 25 is a screen when displaying the image representing the image data by the frame number ten (“10”). The display screen 25 shows “N=010” on the bottom right corner for indicating the frame number of the current image. The display screen also shows an operator assist mark 24 overlapping with the image to enable an instruction for selecting an image.

In the display screen 25, when the camera operator lets her/his finger trace the operation area on the touch panel 7 corresponding to the area of the operator assist mark 24 in a CW (clockwise) direction, the frame number increments and accordingly image data by the file name containing the applicable frame number is read out of the media card 13, followed by displaying the image representing the image data by the frame number eleven (“11”), replacing the image by the frame number ten (“10”) as shown by the display screen 26.

As described above, the camera operator letting the finger trace the operation area of the touch panel 7 corresponding to the operator assist mark 24 in the CW direction increments the frame number so as to display the image representing the image data by a post-counting up frame number, replacing the image by the pre-counting up frame number. A continuation of such tracing operation in the CW direction will cause a scroll display (also simply called a “scroll up”) for displaying one image after another in the sequence of increasing frame numbers.

Meanwhile, in the display screen 25, when the camera operator lets the finger trace the operation area on the touch panel 7 corresponding to the area of the operator assist mark 24 in a CCW (counter clockwise) direction, a frame number decrements, displaying the image representing the image data by the frame number nine (“9”), replacing the image by the frame number ten (“10”) as shown by the display screen 27.

As described above, the camera operator letting the finger trace the operation area of the touch panel 7 corresponding to the operator assist mark 24 in the CCW direction decrements the frame number so as to display the image representing the image data by a post-counting down frame number, replacing the image by the pre-counting down frame number. A continuation of such a tracing operation in the CCW direction will cause a scroll display (also simply called a “scroll down”) for displaying images in the sequence of decreasing frame numbers.

This comprisal enables the camera operator to scroll up or down images by letting the finger trace the operator assist mark 24 on the touch panel 7 in a desired direction.

At the point of displaying the desired image by the above described operation, the camera operator is also enabled to display only the desired image as shown by the display screen 28 by operating the camera 1 in a prescribed way. By this method, the camera operator can enjoy viewing the desired image without the presence of the operator assist mark 24. Also, if the camera operator operates the camera 1 in a prescribed way in this state, an overlapping display of the operator assist mark 24 resumes as shown by the display screen 25, allowing selection of an image again.

Incidentally, the camera operation switches 22 or touch panel 7 can be used as operation means for switching between the state for allowing selection of an image (e.g., display screens 25, 26 and 27) and the one for enjoying viewing an image (e.g., display screen 28).

The following method can be considered as a method for switching between the state for allowing selection of an image and the one for enjoying viewing an image by using the touch panel 6. That is, tapping on the touch panel 6, instead of tracing thereon, changes between the two display screens.

The present embodiment is configured to use the play mode switch 5, as one of the camera operation switches 22 for switching between these two states.

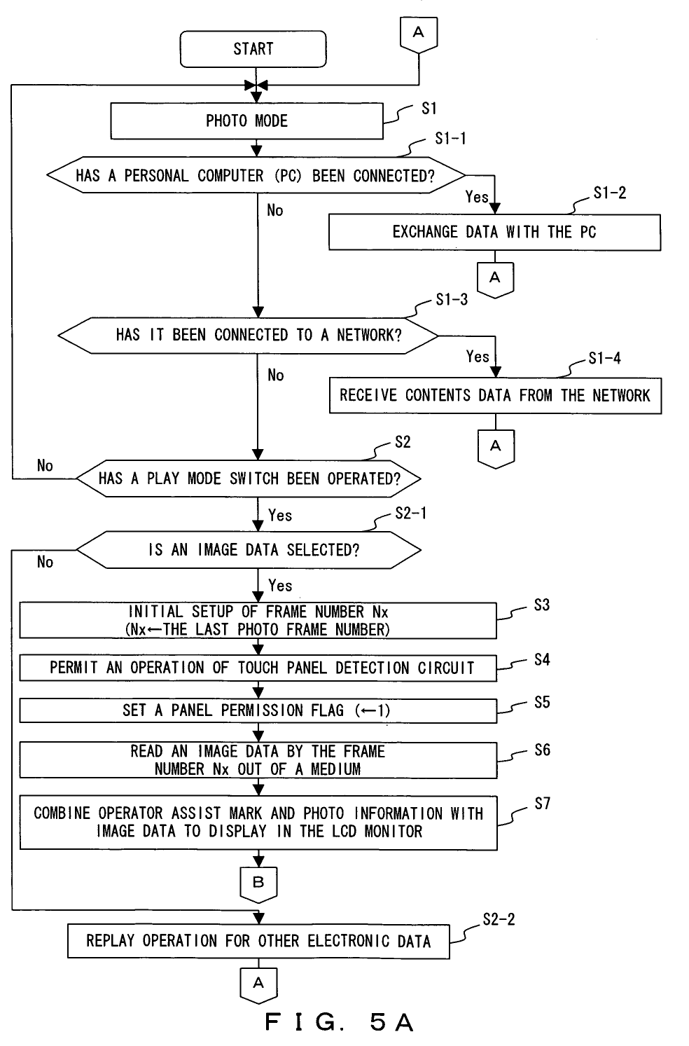

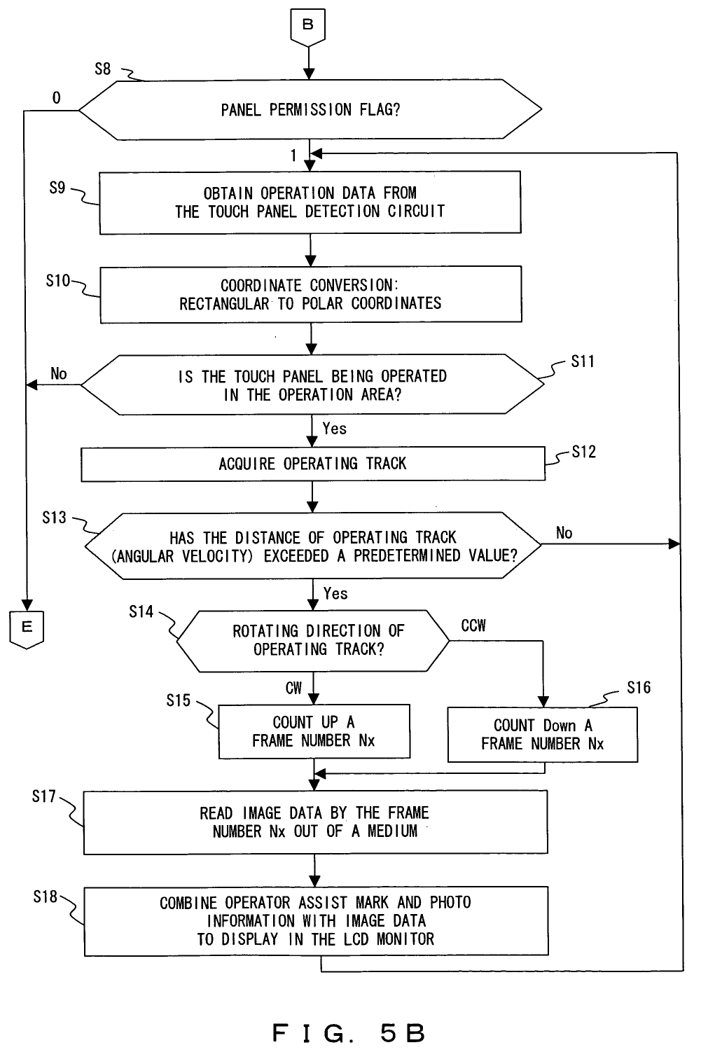

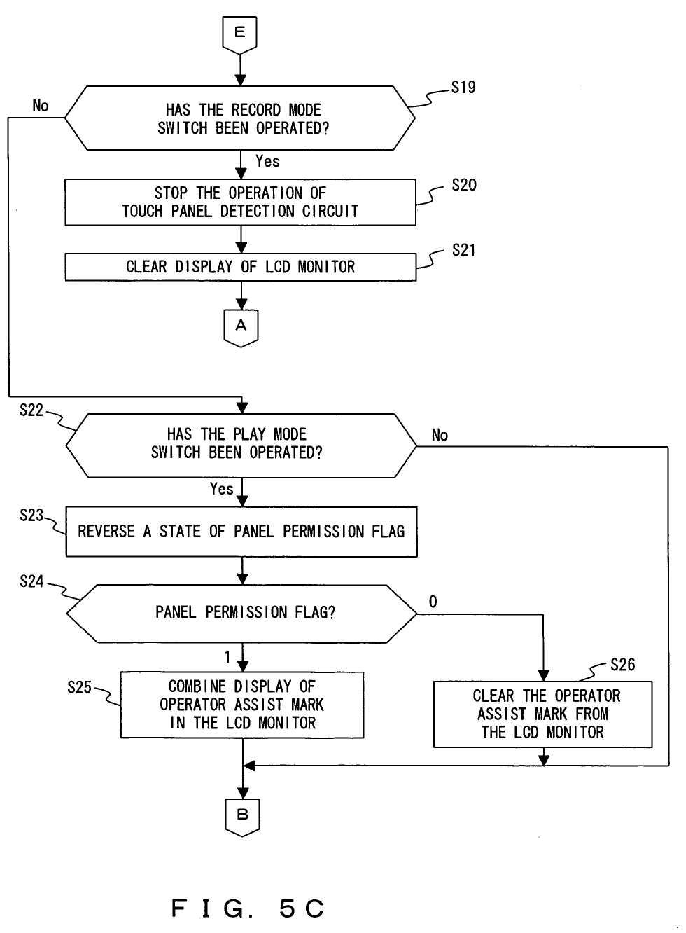

FIGS. 5A, 5B, and 5C are flow charts showing an operation of the digital camera 1, including the above described operation, according to the present embodiment. Note that the operation is carried out by the system controller 12 reading out the control program stored in the flash ROM 10 and executing it.

Referring to FIG. 5A, the present operation starts when one of the camera operation switches 22, that is, a power switch (not shown herein) is turned on so that the system controller 12 first sets the photo mode as operating mode (step 1) (simply “S1” hereinafter).

Incidentally, if the setup is the photo mode, an operation of one of the camera operation switches 22, i.e., the release switch 3, carries out a photographing operation, followed by recording the photographed image data in either the built-in media 52 or media card 13. Meanwhile, viewing of an image representing image data recorded by either the built-in media 52 or media card 13 is possible when the replay mode is setup. Switching to the replay mode is enabled by an operation of the play mode switch 6 as one of the camera operation switches 22. And switching to the photo mode is enabled by an operation of the record mode switch 5 as one of the camera operation switches 22.

The next step is to judge whether or not the camera has been connected with a personal computer (PC) as one of external apparatuses (S1-1), which is usually carried out by using a USB. The USB controller 23 detects a connection with a PC. Detection of the connection with the PC is followed by transmitting either a photographed image by the camera 1 to the PC or electronic data from the PC to camera to be replayed thereby (S1-2). Upon finishing the communication between the camera and PC, the processing returns to S1.

Proceeding to the next step, it is judged whether or not the camera 1 is connected to a network (S1-3). When downloading electronic data which can be replayed by the camera 1 directly from a data base (e.g., a music data base) without the use of a PC, the camera user can connect the camera directly to a LAN. Also, when printing a photographed image data not via a PC, the camera 1 is connected to a LAN, which is carried out by the LAN controller 54. Upon completing download of electronic data (S1-4), the processing proceeds to S1.

Then, it is judged whether or not the play mode switch 6 has been operated (S2) and, if the judgment result is “yes”, the S2-1 ensues, while if it is “no”, the S1 will resume. Note, if the judgment in the S2 is “no” the process returns to S1, setup for the photo mode anew will not be carried out.

If the judgment result in the S2 is “yes”, switch the operation modes from the photo to replay modes to proceed to the next step and judge a category of electronic data to be replayed (S2-1). If an image data has been selected as the one to be replayed, the processing proceeds from the S2-1 to S3, otherwise the processing proceeds to S2-2. The following description deals with an operation of displaying (i.e., replaying) image data as shown by the flow chart of S3 through S26 according to one of the preferred embodiments. Note that the basis of the selection and replay operation of data other than image data (S2-2) is the same. The camera 1 creates a folder or directory according to a category of data in the media card 13 or built-in media 52 to store electronic data. In the S2-1, a folder storing the data to be replayed is selected. The user can select an electronic data to be replayed by operating the arrow switch 51.

Then, set up a frame number Nx (S3). Note that the frame number Nx, is the frame number for image data relating to an image to be displayed by the LCD monitor 18. In the present embodiment, the frame number Nx to be set up in the S3 is the frame number for the image data which has been photographed last, but it is possible to use another frame number if there is corresponding image data.

Then, the processing is to permit the operation of the touch panel detection circuit 19 (S4), which is done by turning a semiconductor switch (not shown herein) for controlling a power supply to the touch panel detection circuit 19 on from off.

Subsequently, set a panel permission flag (S5) which exists for indicating either one of the two states in the replay mode described in association with FIG. 4. Specifically, if the panel permission flag is set (to “1”), the operator assist mark 24 is displayed overlapping with an image so that the camera operator tracing the operator assist mark 24 through the touch panel 7 in either CW or CCW directions increments or decrements a frame number, resulting in displaying image data corresponding to the incremented or decremented frame number in the LCD monitor 18 after it is read out of the media card 13. On the other hand, if the panel permission flag is cleared (to “0”), only an image is displayed, and not the operator assist mark 24, in the LCD monitor 18. This is because either appreciating or examining an image does not need an operator assist mark 24 which rather disturbs a viewing. In this event, selection of an image cannot be done because an operator assist mark 24 is not displayed.

The S5 is followed by reading an image data by the frame number Nx, which has been set up in S4, out of the media card 13 (S6), converting the readout image data to the display size of the LCD monitor 18, combining the converted image data with the operator assist mark 24 and photo information (e.g., frame number) and outputting the combined image data to the LCD monitor drive circuit 20 to display in the LCD monitor 18 (S7) After the operating mode switching to the replay mode through the above described steps S4 through S7, selection of an image is enabled by operating the touch panel 7.

As shown by FIG. 5B, The S7 is followed by judging whether the panel operation flag is “1” or “0” (S8) and proceeding to S9 if the judgment result is “1” or S19 shown by FIG. 5C if the judgment result is “0”.

Then, if the judgment result is “1” in S8, it is followed by obtaining position data (also called “operation data”) relating to the current operating position on the touch panel 7 from the touch panel detection circuit 19 (S9). This step will be skipped, however, if the camera operator has not operated the touch panel 7 in this event.

Incidentally, the configuration is such as to carry out the processing of S9 at every predetermined time period Δt, i.e., a predetermined cycle, when the replay mode is set and the panel permission flag is “1”.

Then, followed by converting coordinates the position data obtained in S9 from rectangular to polar coordinates (S10). This step will be skipped, however, if the camera operator has not operated on the touch panel 7 in S9.

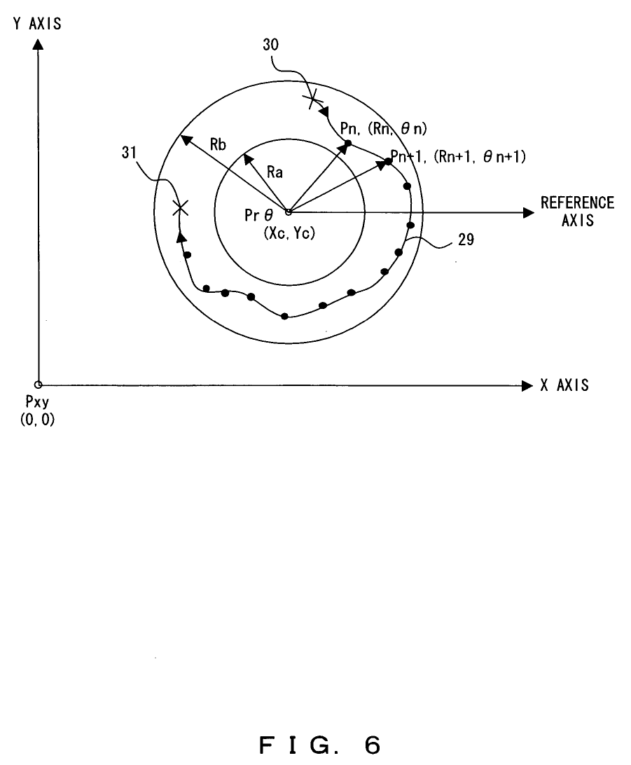

The description at this time deals with a method for converting coordinates from rectangular to polar coordinates by referring to FIG. 6.

FIG. 6 shows a track (also called “operating track”) when a camera operator uses his/her finger for tracing an operation area of the touch panel 7 by following an operator assist mark 24.

As shown by FIG. 6, the present embodiment is configured to place a datum point Pxy at a position corresponding to the lower left position of the display screen of LCD monitor 18 to set up the X and Y axes with the datum point Pxy as the origin (0, 0) of the rectangular coordinates. The touch panel detection circuit 19 outputs detected position data as rectangular coordinate data according to the setup. Incidentally, such an operating track of the camera operator can be approximated by a circular or circumferential curve around the center (Xc, Yc) of the operator assist mark 24. Therefore, the use of polar coordinates is preferable to rectangular coordinates in order to deal with position data of such a track. Accordingly, a reference axis, originating at a reference position Prθ, is established in parallel with the X axis, where the center coordinate (Xc, Yc) of the operator assist mark 24 is defined as the reference position Prθ.

This allows the X and Y axes of the rectangular coordinate system to be converted to R and θ of the polar coordinate system by the following expressions:
R=((X−Xc)ˆ2+(Y−Yc)ˆ2)ˆ(½) (1);
θ32 arctan((Y−Yc)/(X−Xc)) (2)

In order to detect an operating status of the touch panel 7 correctly, it is necessary to compute the conversion expression for converting data in the rectangular coordinate system to that in the polar coordinate system as described above at high speed. But it may not be possible to compute the conversion expression (1) and (2) within the required time if the computing power of the built-in CPU in the system controller 12 is small or the computation cannot occupy the CPU exclusively.

Accordingly, a dedicated arithmetic circuit for the coordinate conversion may be furnished with the touch panel detection circuit 19 as a countermeasure to such a situation, in which case the processing of S10 is only to load in data after the coordinate conversion from the touch panel detection circuit 19.

Returning to FIG. 5B, conversion of position data from rectangular coordinates to polar coordinates as described above is followed by judging whether or not the position data obtained in the S9 (or the position data converted to polar coordinates in S10) is included in the operation area of the touch panel 7 corresponding to the operator assist mark 24 (S11), that is, whether an operation of the touch panel 7 was carried out in the operation area.

And, if the judgment result is “yes”, proceed to S12, while if it is “no”, proceed to S19 shown by FIG. 5C. If the camera operator has not operated the touch panel 7 in S9, however, a judgment result in the current step becomes “no”.

This judgment processing judges that the touch panel 7 has not been operated in the operation area if it has been operated outside the operation area.

Note that a use of position data converted to polar coordinates in the S10 makes it possible to judge an operating position of the touch panel 7 by the polar coordinate system for a judgment in the S11. For example, where the polar coordinate data converted in S10 is (Rn, θn) and the operating area of the touch panel 7 corresponding to the operator assist mark 24 is regarded to be a donut shape defined by the radii Rb and Ra as shown by FIG. 6, and if the Rn is equal to or greater than Ra, and is equal to or smaller than Rb, then the judgment is that the operation has been carried out in the operation area. That is, the judgment in the S11 can be made by the following expression:
Ra≦Rn≦Rb (3)

The configuration allows a judgment as to whether or not an operation has been done in the operation area of the touch panel 7 corresponding to the operator assist mark 24.

Note that the present embodiment is configured to define the relationship of Ra and Rb with RA and RB as Ra=RA and Rb=RB, but it is possible to set Rb a little larger or smaller than RB, and Ra a little smaller or larger than RA if appropriate.

In the judgment of the S11, if the judgment result is “yes”, that is, the Rn satisfies the above described expression (3), the subsequent processing is to calculate an operating parameter, that is, to acquire a distance and direction of the operating track (i.e., an operating distance and operating direction of the tracing operation), based on the position data (i.e., the latest position data) and the one obtained earlier by a prescribed time Δt (S12). If, however, position data at a prescribed time Δt earlier has not been obtained, and hence it is not possible to acquire a distance or direction of operating track, then the current step will be skipped.

Now let a method for acquiring a distance and direction of an operating track based on two position data points be described by referring to FIG. 6.

In FIG. 6, an operating track 29 indicates the operating track when the camera operator has let the finger trace CW from an operation start position (i.e., marked X in FIG. 6) 30 to the operation end position (i.e., marked X in FIG. 6) 31 in the operation area of the touch panel 7 corresponding to the operator assist mark 24. And the dot points shown on the operating track 29 are the points applicable to the position data detected (i.e., acquired) at a prescribed time interval Δt.

On the operating track 29, where defining as a polar coordinate (Rn, θn) of an operating position Pn at a certain clock time and a polar coordinate (Rn+1, θn+1) of the operating position Pn+1 at a prescribed time Δt after the aforementioned time, and assuming the Rn and Rn+1 satisfy the conditions of the above described expression (3), then the distance and direction of the operating position is figured out by the following expression (4):
θv=(θn+1−θn) (4),
where θv is a distance of the operating track (i.e., also a track change rate (angular velocity) representing the operating distance). And the direction of the operating track (i.e., operating direction) is determined by whether the value of θv is positive or negative. That is, the direction of the operating track is CCW when the value of θv is positive, while it is CW when that of θv is negative.

Returning to FIG. 5 again, acquisition of a distance and direction of the operating track thusly is followed by judging whether or not the distance of the operating track (i.e., angular velocity) θv has exceeded a predetermined value θvo (S13) and, if the judgment result is “yes”, proceed to the S14, otherwise return to the S9.

Incidentally, the present embodiment is configured to change a frame number Nx when θv exceeds a predetermined value θvo, while the value of θvo may be fixed, or it may be changed by the camera operator considering usability and preference.

If the judgment result of the S13 is “yes”, the successive processing is to judge whether the direction of the operating track is CW or CCW (S14) and, if the judgment result is CW (i.e., if θv is negative), count up a frame number Nx, while if the judgment result is CCW (i.e., if the θv is positive), count down the frame number Nx (S16).

Incidentally, the relationship between the CW/CCW direction and the counting up/down may be settable by the camera operator considering usability and preference.

The above description has described a method for counting up or down a frame number for image data. If the electronic data to be replayed is music data, a number assigned in relation with a music title is incremented or decremented along with the frame number. If electronic data to be replayed is book data, as one example of text data, a number assigned in relation with a book title is incremented or decremented; or a number assigned in relation with a page number for the already selected book data.

The above step is followed by reading the image data by the frame number Nx out of the media card 13 (S17), converting the readout image data to the display size of the LCD monitor 18, combining the converted image data with the operator assist mark 24 and photo information (e.g., frame number, et cetera) and outputting the combined image data to the LCD monitor drive circuit 20 for displaying in the LCD monitor 18 (S18). Then the processing returns to S9.

On the other hand, as shown by FIG. 5C, if the judgment result for S8 is “0”, or that of S11 is “no”, whether or not the record mode switch 5 has been operated (S19) is judged and, if the judgment result is “yes”, proceed to S20, while if the judgment result is “no”, then proceed to S22.

If the judgment result for the S19 is “yes”, then the operation mode is switched from the replay mode to photo mode to stop the operation of the touch panel detection circuit 19 (i.e., stop power supply thereto) (S20) and clear the display in the LCD monitor 18 (S21), then return to S1 shown by FIG. 5A.

On the other hand, if the judgment result for the S19 is “no”, judge whether or not the play mode switch 6 has been operated (S22) and, if the judgment result is “yes”, proceed to S23, while if the judgment result is “no”, then return to S8 shown by FIG. 5B.

If the judgment result for the S22 is “yes”, then reverse a state of the panel permission flag (S23), that is, if it is “1”, reset it to “0”, while if it is “0”, reset it to “1”.

The above step is followed by judging whether the panel permission flag is “1” or “0” (S24) and, if the judgment result is “1”, displaying the operator assist mark 24 overlapping with the image already displayed by the LCD monitor 18 (S25), while if the judgment result is “0”, then clear the operator assist mark 24 from the image displayed thereby (S26), followed by returning to S8 shown by FIG. 5B.

As a result of the processing in S22 through S26, a discretionary selection of the state for enjoying viewing an image and the one allowing a selection of an image (i.e., a state allowing an image scroll), in the replay mode.

Note that the above described processing flow exemplifies the case of acquiring an angular velocity as a distance of an operating track (i.e., operating distance), but it is possible to acquire an angle (which is also a moving distance of an operating position) instead of the angular velocity. In this case, whenever the acquired angle exceeds a prescribed angle, a frame number Nx is changed.

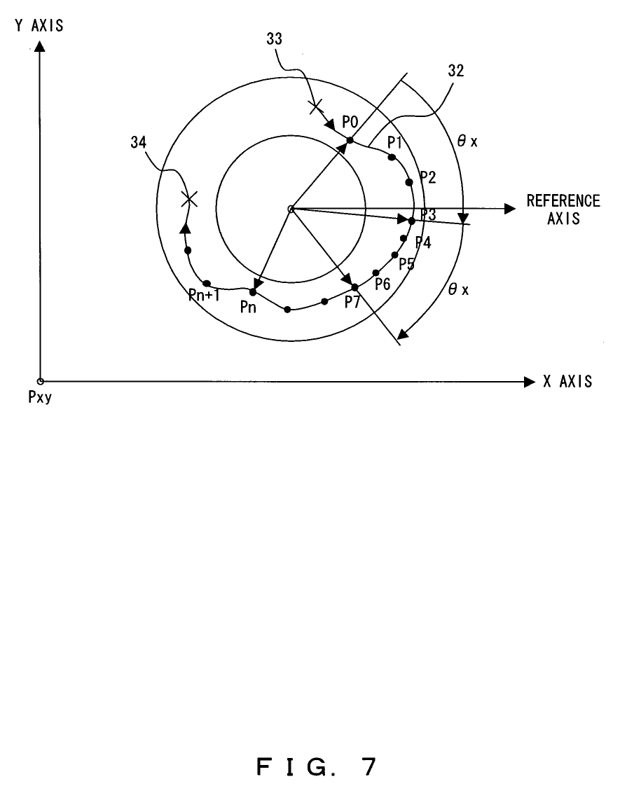

FIG. 7 describes a method for figuring out an angle as a distance of an operating track.

In FIG. 7, an operating track 32 indicates the operating track when the camera operator has let the finger trace CW from an operation start position (i.e., marked X in FIG. 7) 33 to the operation end position (i.e., marked X in FIG. 7) 34 in the operation area of the touch panel 7 corresponding to the operator assist mark 24. And the dots shown on the operating track 32 are the points applicable to the position data detected (i.e., acquired) at a prescribed time interval Δt.

Here, where the P0 on the operating track 32 is taken as a measuring start reference point by an operating angle θx, it is figured out for every position data obtained sequentially at a prescribed interval Δt following P0 with the polar coordinate (R0, θ0) of the P0.

For example, if an operating angle θx (i.e., θ0 minus θ3) has just exceeded a prescribed value θxo at the P3 (R3, θ3) for the first time, a frame number Nx is changed at this event. Then, the processing establishes P3 as a new measurement start reference point, followed by figuring out an operating angle for every position data obtained sequentially at a prescribed interval Δt following P3 again.

For example, if an operating angle θx (i.e., θ3 minus θ7) exceeds a prescribed value θxo at P7 (R7, θ7) for the first time, a frame number Nx is changed at this event again.

Such an operation will be repeated as long as the camera operator lets the finger keep tracing the operation area of the touch panel 7 corresponding to the operator assist mark 24.

Incidentally, a value of θxo may be fixed, or it may be changed by the camera operator considering usability and preference.

And, in the case of figuring out an angle as a distance of operating track, the direction of an operating track (i.e., operating direction) is determined by the operating angle θx being either positive or negative. That is, if the operating angle θx has a positive value, the direction is CCW, while if it has a negative the direction is CW.

As described above, the present embodiment is configured to enable desired image data to be selected and displayed easily by the camera operator merely by letting the finger, et cetera, trace the operation area of the touch panel 7 corresponding to the operator assist mark 24 displayed in the LCD monitor 18.

### Second Embodiment

The first embodiment has been configured to switch a state allowing a selection of image (i.e., the state for allowing scrolling an image) with a state for enjoying viewing an image by operating the play mode switch 6 in the replay mode, while the present second embodiment is configured to switch by operating the touch panel 7.

Specifically, upon detecting a completion of image selection operation in the state for allowing a selection of image (e.g., detecting the finger leaving the operation area of the touch panel 7 corresponding to the operator assist mark 24), switching to a state for enjoying viewing an image in which state a tapping on an area of the touch panel 7 (i.e., a light tapping) will switch to the state for allowing selection of an image.

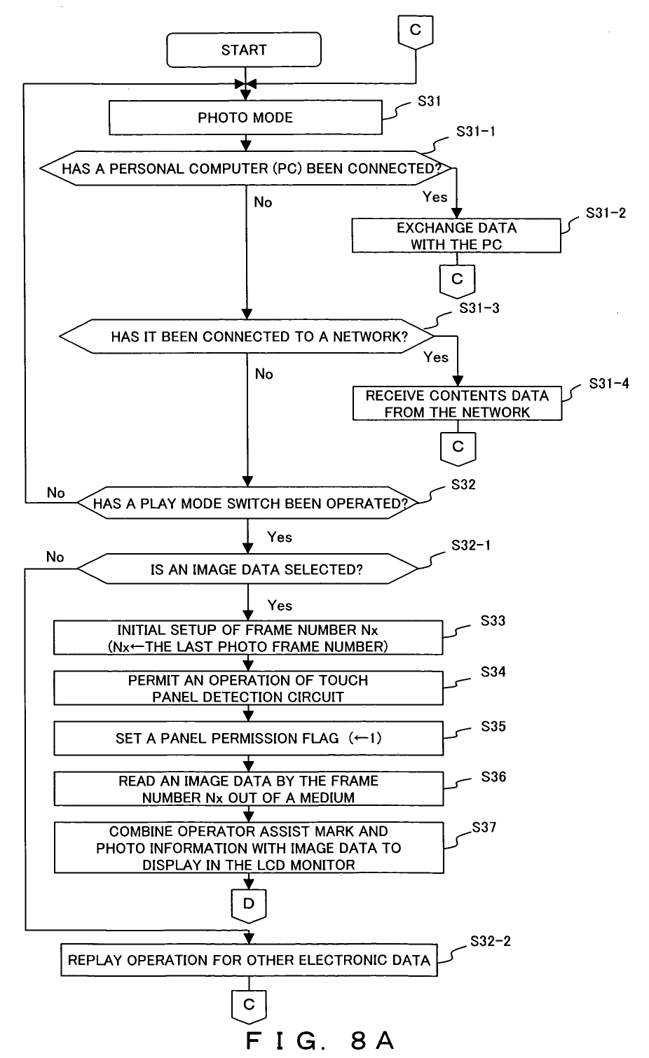

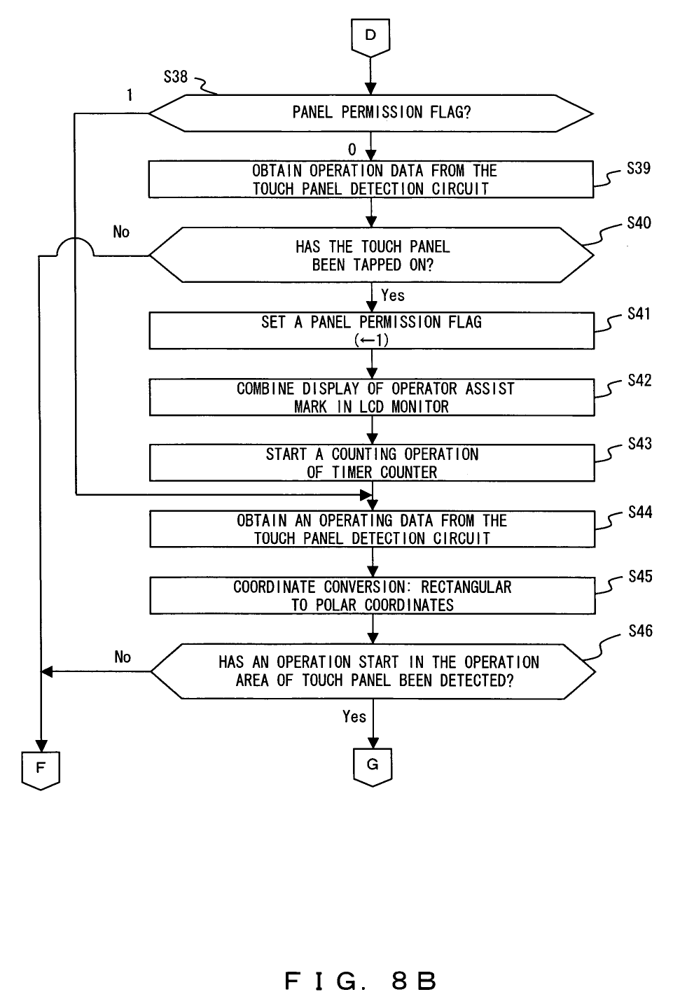

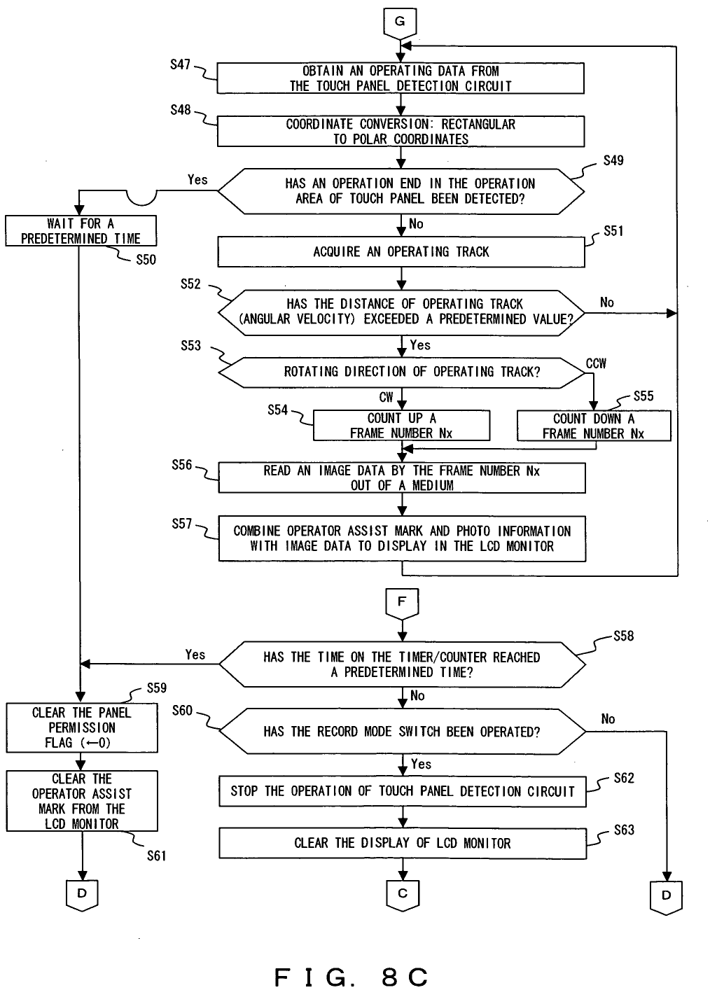

FIGS. 8A, 8B, and 8C are flow charts showing an operation of a digital camera 1 according to the present embodiment, including the above noted switching operation. Note that the processing flow corresponds to that shown by FIGS. 5A, 5B, and 5C.

In FIG. 8A, the S31, S31-1 through S31-4, S32, S32-1 through S32-2, and S33 through S37 are the same processes as the S1, S1-1 through S1-4, S2, S2-1 through S2-2, and S3 through S7, respectively, shown by FIG. 5A.

The S37 is followed by judging whether the panel operating flag is “1” (i.e., a state allowing selection of an image) or “0” (i.e., a state for enjoying viewing an image) as shown by FIG. 8B (S38) and, if the judgment result is “1”, proceed to S44, while if “0”, proceed to S39.

If the judgment result for S38 is “0”, the successive processing is to obtain position data (also called “operation data”) relating to the current operating position of the touch panel 7 from the touch panel detection circuit 19 (S39), judge whether or not the touch panel 7 has been operated by tapping thereon based on the position data (S40) and, if the judgment result is “yes”, proceed to S41, while if “no”, proceed to S58 shown by FIG. 8C. Incidentally, if the camera operator has not operated the touch panel 7 in S39, the judgment result for S40 becomes “no”.

If the judgment result for S40 is “yes”, the successive processing is to set the panel permission flag (to “1”) (S41) and display the operator assist mark 24 overlapping with a displayed image in the LCD monitor 18 (S42), enabling the camera operator to know that the state now allows selection of an image. The S42 is followed by starting counting a timer/counter (not shown herein) of the system controller 12 (S43). This counting is done for a processing of switching to the state for enjoying viewing an image by clearing the operator assist mark 24 from the displayed image if an operation for selecting an image (i.e., a scroll operation) is not done within a predetermined time after switching to the state for allowing selection of an image. The timer/counter measures time in order to judge whether or not the predetermined time has elapsed.

Following S43, or if the judgment result for S38 is “1”, the successive processing is to obtain position data (also called “operation data”) relating to the current operating position of the touch panel 7 from the touch panel detection circuit 19 (S44) and apply coordinate conversion to the position data from rectangular to polar coordinates (S45). But here, S44 and S45 will be skipped if the camera operator has not operated the touch panel 7. Then, judge whether or not the coordinate-converted position data in S45 is included in the operation area of the touch panel 7 corresponding to the operator assist mark 24 (i.e., whether or not an operation start on the touch panel 7 in the operating area has been detected) (S46) and, if the judgment result is “yes”, proceed to S47 shown by FIG. 8C, while if it is “no”, proceed to S58 shown by FIG. 8C. Incidentally, if the camera operator has not operated the touch panel 7 in S44, the judgment result for the current step becomes “no”.

That is, the processing in S44 through S46 detect whether or not the camera operator has started to trace the operation area of the touch panel 7 corresponding to the operator assist mark 24.

If the judgment for S46 is “yes”, as shown FIG. 8C, the processing in S47 through S57 are the same as those for S9 through S18 shown by FIG. 5B. That is, the camera operator by letting a finger, et cetera, trace the operation area of the touch panel 7 corresponding to the operator assist mark 24 counts a frame number up or down to combine the operator assist mark 24 overlapping with an image representing the corresponding image data in the LCD monitor 18.

Note that the S49 is for judging whether or not an operation end on the touch panel 7 in the operation area corresponding to the operator assist mark 24 is detected by carrying out the same processing as in S11, in which, if the judgment result for S49 is “yes” under the condition of the judgment result for S11 being “yes”, the processing proceeds to S50, while if the judgment result for S49 is “no” under the condition of the judgment result for S11 being “no” the processing proceeds to S51.

If the judgment result for S49 is “yes”, the successive processing is to wait for a predetermined time (S50) and then proceed to S59. Note that the processing of S50 is designed for preventing the operator assist mark 24 from being cleared immediately after detecting an operation end so as to avoid an uncomfortable feeling on the part of the camera operator caused by clearing the operator assist mark 24 immediately after the aforementioned detection. A configuration so as to return to S47 if the touch panel 7 is operated during the aforementioned waiting period in the current step is also possible. This enables the camera operator to continue the operation if he/she inadvertently lets the finger come off the touch panel 7.

On the other hand, if the judgment result for S40 shown by FIG. 8B is “no”, or that for S46 shown by FIG. 8B is “no”, the successive processing is to judge whether or not a time counted by the timer/counter has reached a predetermined time (S58) and, if the judgment result is “yes”, proceed to S59, while if no, then proceed to S60.

After S50, or if the judgment result for S58 is “yes”, clear the panel permission flag (to “0”) (S59) and clear the operator assist mark 24 from the image displayed in the LCD monitor 18 (S61). By this method, the camera operator becomes aware of the camera switching to the state for allowing enjoying viewing an image. The S61 is then followed by the processing returning to S38 shown by FIG. 8B.

On the other hand, if the judgment result for S58 is “no”, judge whether or not the record mode switch 5 has been operated (S60) and, if the judgment result is “yes”, proceed to S62, while if “no”, return to S38 shown by FIG. 8B.

If the judgment result for S60 is “yes”, the successive processing is to switch the operation mode from the replay mode to photo mode and stop the operation of the touch panel detection circuit 19 (S62) and clear the display in the LCD monitor 18 (S63). Then the processing returns to S31 shown by FIG. 8A.

As described above, the present embodiment is configured to switch between the state for allowing selection of an image and the one for enjoying viewing an image by operating the touch panel 7 in the replay mode.

### Third Embodiment

In the first and second embodiments, the use of a donut shaped operator assist mark 24 displayed together with an image enabled an operation method associating a dial shaped rotating operation member through the use of the touch panel 7, thereby making an operating track by the camera operator an approximate curve, whereas the present third embodiment is configured to make an operator assist mark displaying overlapped with an image in the manner of a belt along a diagonal line across the display screen, hence an operating track of the camera operator approximately becomes a line.

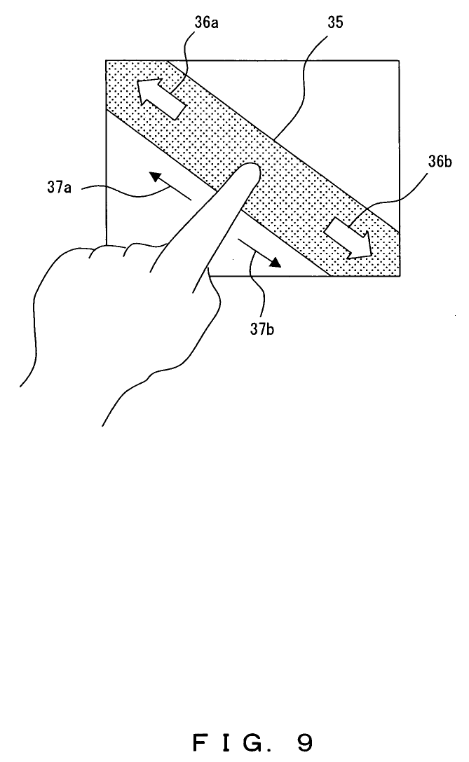

FIG. 9 shows an operator assist mark according to the present embodiment. Note that FIG. 9 exemplifies a screen displayed in the LCD monitor 18 when the camera operator indicates a selection of image data through the touch panel 7 in the replay mode.

As shown by FIG. 9, an operator assist mark 35 is displayed along a diagonal line of the display screen together with an image as a band with a predetermined width. Note that the reason for setting up the operator assist mark 35 diagonally is that it is ergonomically easier to operate diagonally in moving the finger while holding the digital camera 1. It is also because the length of an operating track can be a maximum. This configuration makes it easier to operate even if an LCD monitor is small.

Also displayed include arrow marks 36a and 36b being set up along the diagonal line toward both ends of the operator assist mark 35 for indicating the operating directions in order to notify the camera operator of the operation method comprehensibly.

This enables the camera operator to let his/her finger, et cetera, trace in the direction of arrows 37a or 37b within the operation area on the touch panel 7 corresponding to the area (i.e., the shaded area of FIG. 9) of the operator assist mark 35 displayed in the LCD monitor 18, that is, to let the finger, et cetera, trace the operator assist mark 35 on the touch panel 7 in the direction of arrows 37a or 37b, thereby instructing the camera 1 to select an image data, et cetera, for example.

The operator assist mark shown by FIG. 9 is one example, but it may be any mark other than the one shown by FIG. 9 as long as it is a figure or sign for indicating comprehensibly an area to be operated by the camera operator.

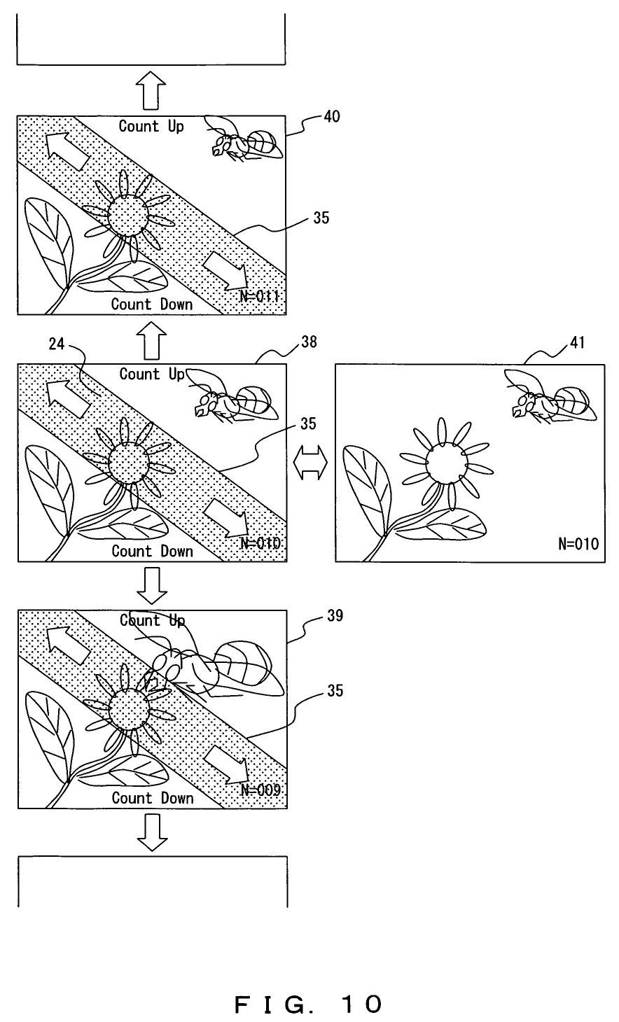

FIG. 10 exemplifies a change of screen displayed by the LCD monitor 18 when the camera operator operates the touch panel 7 for selecting desired image data, et cetera, in the replay mode.

In FIG. 10, a display screen 38 is a screen displaying an image representing the image data by the frame number ten (“10”). Displayed on the lower right side of the display screen 38 is “N=010” for indicating that the frame number of the image is ten (“10”). Also displayed in the display screen is the operator assist mark 35 overlapping with the image as described in relation to FIG. 9 for enabling an instruction for selecting an image. Furthermore, also displayed are assist signs (i.e., “count up” and “count down” as shown in FIG. 10) for notifying the camera operator of the correlation between the operating direction and counting direction on the upper and lower ends of the display screen, however FIG. 9 does not shown these signs.

In the display screen 38, as the camera operator lets his/her finger trace the operation area of the touch panel 7 corresponding to the operator assist mark 35 in the direction of upper left to lower right for example, a frame number decrements, thereby replacing the image representing the image data by the frame number ten (“10”) with an image representing an image data by the frame number nine (“9”) as shown by a display screen 39.

Conversely, the finger tracing the operation area of the touch panel 7 corresponding to the operator assist mark 35 in the direction of lower right to upper left in the display screen 38 makes a frame number count up, thereby replacing the image representing the image data by the frame number ten (“10”) with an image representing image data by the frame number eleven (“11”) as shown by a display screen 40.

As such, a finger tracing the operation area of the touch panel 7 corresponding to the operator assist mark 35 in the direction of upper left to lower right, or that of lower right to upper left, makes an image displayed by the LCD monitor 18 scroll up, or down, respectively. Here, the enabling or disabling of the carrying out of an operation relating to counting up or down a frame number may be decided by using two parameters as follows. One is to use a moving distance of a finger at the time of a tracing operation, that is, a decision for enabling or disabling the carrying out of an operation relating to counting a frame number up or down in response to the distance of an operating track (i.e., a length of an operating track). The other is a moving velocity of a finger at the time of a tracing operation, that is, the aforementioned decision in response to a rate of change of a distance of operating track per unit time. Note that the moving distance and moving velocity of the finger are one example of operating distance.

Meanwhile, the camera operator is also enabled to display an image only as shown by the display screen 41 by operating the camera 1 in a prescribed way just when displaying a desired image as described above. Here, the prescribed operation includes an operation of the play mode switch 6 described in the first embodiment, or a tapping operation of the touch panel 7 described in the second embodiment, for example. This configuration enables the camera operator to enjoy viewing a desired image in the state where there is no operator assist mark 35 or assist sign. Also in this state, the camera operator is enabled to display the operator assist mark 35 and assist sign overlapping with the image again by a prescribed operation as shown by the display screen 38, thereby allowing selection of an image.

Note here that the operation of the digital camera 1 according to the present embodiment including such switching operations is made possible based on the operations as per the flow charts shown by FIGS. 5A, 5B, and 5C, or FIGS. 8A, 8B, and 8C, except that a continuous operation is not possible as with the donut shaped operator assist mark 24 in an operation according to the present embodiment because the operator assist mark 35 is shaped as a band. Accordingly, it is desirable to configure to continue the state for allowing a selection of image when detecting an operation of the touch panel 7 again within a prescribed time of detecting an operating end of the touch panel 7 as described for the processing of S50 shown by FIG. 8C. This configuration enables the camera operator to scroll the images up or down continuously.

As described above, the present embodiment is configured to provide the operator assist mark in the manner of a band along a diagonal line of the display screen, thereby improving the operability so that it is better than such an apparatus (e.g., refer to the earlier noted Japanese laid-open patent application publication No. 2004-104594) configured to instruct an operation in either the horizontal or vertical directions.

The above descriptions have dealt with the first through third embodiment. While these embodiments have exemplified image data for content data as the subject of selection and display, it is of course possible to apply them to sound data in which case the state for allowing selection of an image allows selection of sound data, while the state for enjoying viewing an image replays sound. Alternatively, book data (i.e., electronic data representing a book) recorded in advance exemplifying text data of the media card 13 will make book data as content data the subject of selection and display. In this case, book data is selected by displaying the title of a book in the state for allowing the selection of image, and the content of the book is displayed in the state for enjoying viewing an image.

Meanwhile, the first embodiment is configured to make the operator assist mark 24 in the manner of a donut, but it is possible to make it in the manner of a circle for example.

The above descriptions have disclosed the preferred embodiments of applying a replay apparatus of the present invention to an electronic still camera. The present embodiments according to the present invention can also be applied to portable electronic apparatuses, in addition to the electronic still camera, including electronic apparatuses with a compact display screen such as a mobile phone, pocket computer, PDA (personal digital assistant), digital audio player, electronic dictionary or translator, et cetera.

In the meantime, a PC is capable of executing a plurality of application software. A window opens up on the monitor screen of a PC for every application so that the user can control an application by operating the GUI (graphical user interface) placed in the applicable window. There are also touch panels attachable to a monitor screen. Starting a plurality of applications makes a plurality of windows coexist in the monitor display, sometimes overlapping with one another to hamper a view. Making a window screen small reduces interference with other windows, hence improving user convenience. Such a small window screen may be applied by the technique put forth by the present invention when selecting electronic data, setting up with parameters, et cetera.

Incidentally, the position and size of the operator assist mark with respect to the display screen are fixed in the above descriptions. They may be, however, configured as settable according to the user preference in consideration of convenience.

It goes without saying that, for all the detailed description about the present invention, the above described embodiments in no way limit the present invention which can rather be improved or modified in various ways within the scope thereof.

As described in detail, the present invention enables selection and replay of desired electronic data such as an image, music and text in a simple operation by using a touch panel.

What is claimed is:

1. A replay apparatus comprising:
a record circuit for recording electronic data;
a display monitor for displaying the electronic data;
a touch panel placed on and overlapping with the display monitor;
a detection circuit for detecting an operating position of the touch panel;
a switching circuit for switching between a first and a second operating state, the former to display the electronic data and an operator assist mark for indicating an operation area of the touch panel in the display monitor, and the latter to display only the electronic data in the display monitor;
a selection circuit for calculating an operating parameter based on operating positions relating to a tracing operation in an operation area detected by the detection circuit at least two different times when the tracing operation is carried out in the operation area of the touch panel in the first operating state, and for selecting the electronic data based on the calculation result.

2. The replay apparatus according to claim 1, wherein
the switching circuit switches between the first and second operation states in response to an operation on an operation unit comprised by the replay apparatus.

3. The replay apparatus according to claim 1, wherein
the switching circuit switches from the first to second operation state in response to an end of tracing operation in an operation area of the touch panel, and switches from the second to first operation state in response to a tapping operation of the touch panel.

4. The replay apparatus according to claim 1, wherein.
the switching circuit switches to the second operation state if an operation of the touch panel is not carried out for a predetermined time period in the first operation state.

5. The replay apparatus according to claim 1, wherein
the selection circuit calculates an operating velocity and operating direction as the operating parameter, increments or decrements a number corresponding to an electronic data to be displayed in the display monitor according to the operating direction and selects an electronic data corresponding to the incremented or decremented number when the calculated operating velocity exceeds a predetermined velocity.

6. The replay apparatus according to claim 1, wherein
the selection circuit calculates a moving distance of operating positions and operating direction as the operating parameter, increments or decrements a number corresponding to an electronic data to be displayed in the display monitor according to the operating direction and selects an electronic data corresponding to the incremented or decremented number when the calculated operating distance exceeds a predetermined distance.

7. The replay apparatus according to claim 1, wherein
the display monitor displays an electronic data selected by the selection circuit.

8. The replay apparatus according to claim 1, wherein
the operator assist mark is shaped as a donut.

9. The replay apparatus according to claim 1, wherein
the operator assist mark is shaped as a band with a predetermined width along a diagonal line of the display monitor.

10. The replay apparatus according to claim 1, wherein
the electronic data is content data including at least one of image data, sound data or text data.

11. The replay apparatus according to claim 1, wherein
the operating parameter includes an operating distance and operating direction relating to a tracing operation.

12. A method for replaying content data for use in a replay apparatus which comprises a record medium recording content data, a display monitor for displaying the content data, and a touch panel placed on and overlapping with the display monitor, comprising:
a first condition for displaying, in the display monitor, the content data and an operator assist mark for indicating an operation area of the touch panel, selecting the content data based on an operating parameter relating to a tracing operation in the operation area, and displaying the selected content data in the display monitor; and
a second condition for displaying only the content data in the display monitor, wherein
the first and second conditions are switched in accordance with a prescribed operation carried out on the replay apparatus.

13. The replaying method according to claim 12, wherein
the operator assist mark is shaped as a donut.

14. The replaying method according to claim 12, wherein
the operator assist mark is shaped as a band with a predetermined width along a diagonal line of the display monitor.

15. The replaying method according to claim 12, wherein
the content data includes at least one of image data, sound data or text data.

16. The replaying method according to claim 12, wherein
the operating parameter includes an operating distance and operating direction relating to a tracing operation.

17. A method for replaying content data for use in a replay apparatus which comprises a record medium for recording content data, a display monitor for displaying the content data, and a touch panel placed on and overlapping with the display monitor, comprising the steps of
displaying, in the display monitor, the content data and an operator assist mark for indicating an operation area of the touch panel, selecting the content data based on an operating parameter relating to a tracing operation in the operation area, and displaying the selected content data in the display monitor;
clearing the operator assist mark and displaying only the selected content data in the display monitor; and
switching from one of the two display operation states to the other in accordance with a prescribed operation carried out on the replay apparatus.

18. The replaying method according to claim 17, wherein
the content data includes at least one of image data, sound data or text data.

19. The replaying method according to claim 17, wherein
the operating parameter includes an operating distance and operating direction relating to a tracing operation.
